(19) United States
(12) Patent Application Publication
(10) Pub. No.: US 2005/0132076 A1
(43) Pub. Date: Jun. 16, 2005

(54) Method and system for showing web pages over internet and wireless communication networks in specific page designs and colors to indicate specific meanings of analytic information

(76) Inventor: Tawei Lin, Taipei (TW)

Correspondence Address: RABIN & BERDO, P.C., Suite 500, 1101 14th Street, N.W., Washington, DC, 20005, US

(21) Appl. No.: 10/732,355

(22) Filed: Dec. 11, 2003

(51) Int. Cl. G06F 15/16

(52) U.S. Cl. 709/230

(57) ABSTRACT

A method and system for showing web pages over Internet and wireless communication networks in different page designs and colors to indicate specific meanings of analytic information obtained on the basis of psychology and various theories about fortune telling, including the denomination science, for telling a user's fortune. The system includes an input program, a logic decision program, a background databank, a fortune result reference table, and an output device. The method includes the steps of opening a membership page (A1), opening an introductory page for a user to enter personal information (A2), verifying the entered information (A3), corresponding the entered information to a background databank (A4), generating a fortune result (A5), and printing a discount coupon, if the user selects to do so (A6).

### FIELD OF THE INVENTION

The present invention relates to a method and system for showing web pages over Internet and wireless communication networks in specific page designs and colors to indicate specific meanings of analytic information obtained on the basis of personal information, psychology, and various eastern and western theories about fortune telling, particularly the denomination science, for telling a user's fortune on a web site. Personal information is entered by the user and corresponded to and analyzed according to data stored in a background databank to generate an analytic result about the user's fortune. The fortune result is shown on a specific page design and in a specific color, so that the user may know within what grade or type of fortune the analytic information falls as soon as seeing the specific color. Therefore, increased fun is created in fortune telling on a web site.

### BACKGROUND OF THE INVENTION

It is very popular to provide services about fortune telling based on analysis of a user's name over Internet and many other wireless communication networks. There are many web sites that provide fortune-telling services and have become a large group that may be searched at different portal sites, indicating that fortune telling is widely welcome by users over Internet.

The web site providing the service of fortune telling usually uses information about a user's background to provide an analysis of the user's fortune at the time the information is provided. For example, a fortune analyzing web site using the denomination science as a basis to provide basic analyses and suggestions about a user's fortune, marriage, business, property, etc. Currently, all the existing web sites providing the analytic information about the user's fortune simply show the web pages displaying the analytic information, either boding well or ill, in the same color and design. Different results from the analysis representing different grades of well and ill fortune are not distinguished with colors or color shades. Therefore, whatever the user has about the analytic information is always descriptive words on a monotonous page without providing the user with special fun in fortune telling. The fortune telling web site is therefore less attractive to users.

Therefore, it is desirable to develop a method and system to show the analytic information about a user's fortune on a web site in a manner that is more attractive to users.

### SUMMARY OF THE INVENTION

A primary object of the present invention is to provide a method and system for showing web pages over Internet and wireless communication networks in specific page designs and colors to indicate specific meanings of analytic information about a user's fortune. Each of the colors indicates a specific condition of the user's fortune, so that the user sees the specific color to immediately know his or her fortune.

Another object of the present invention is to provide a method and system for showing web pages over Internet and wireless communication networks in specific page designs and colors to indicate specific meanings of analytic information about a user's fortune. A page providing a discount coupon is shown when the displayed page design and color represent an analytic result of fortune that does not meet a preset low standard, so that the user is encouraged to buy products or services provided by the web site to, for example, get more suggestions on his or her fortune.

With the above arrangements, fortune telling over a web site is not limited to monotonous word description. On the contrary, the user may enjoy the fun of fortune telling through operating a computer when different colors and page designs are shown on the web pages. Since the method and system of the present invention works on a platform that may be applied on the Internet and other wireless communication networks, it is very easy and interesting for a user to interact with the fortune telling web sites through a computer system.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing steps included in the method of the present invention;

FIGS. 2A and 2B show two dialog boxes separately for confirming a membership's email address (FIG. 2A) and updating a membership's email address;

FIG. 3 shows an introductory page of the system of the present invention, on which a user may enter his personal information, such as name and sex;

FIG. 4 is a fortune result reference table showing different analytic results of fortune and specific colors corresponding to the different fortune results;

FIG. 5 is a first example of the pages included in the system of the present invention;

FIG. 6 is a second example of the pages included in the system of the present invention;

FIG. 7 is a third example of the pages included in the system of the present invention;

FIG. 8 is a fourth example of the pages included in the system of the present invention;

FIG. 9 is a fifth example of the pages included in the system of the present invention;

FIG. 10 is a sixth example of the pages included in the system of the present invention;

FIG. 11 is a page included in the system of the present invention, on which a user may enter to select printing a discount coupon;

FIG. 12 shows the discount coupon provided by the system of the present invention through the page of FIG. 11; and

FIG. 13 is a block diagram showing a systematic framework of the present invention.

### DETAILED DESCRIPTION OF THE PREFERRED EMBODIMENTS

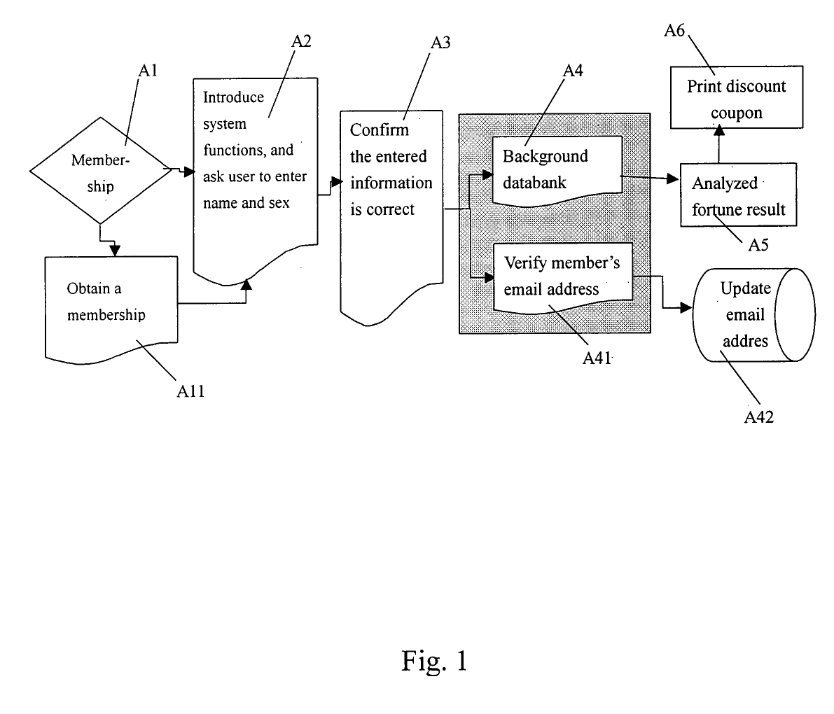

Please refer to FIG. 1 that is a flowchart showing steps included in a method of the present invention for showing web pages over Internet and wireless communication networks in different page designs and colors to indicate specific meanings of analytic information for telling a user's fortune. More specifically, the present invention relates to a method and a system in which the denomination science is used as a basis to analyze a person's fortune, and the analytical result is represented using a specific page design in a specific color.

The method of the present invention mainly includes the following steps:
open a “membership” page and determine whether the user is a membership (Step A1);
if the user is not a membership, an inviting page is shown to invite the user to obtain the membership (Step A11;
an introductory page is opened to introduce the functions of the system, and the user may enter his or her name and sex on this page (Step A2);
the user is prompted to confirm that the entered data on the introductory page is correct (Step A3);
correspond a string of the entered data to a background databank (Step A4), and verify the user's email address at the same time (Step A41); if the user, who is now a membership, wants to change his or her email address, a dialog box is shown for the user to update the email address (Step 42);
a fortune result is generated according to data in the databank corresponding to the entered data (Step A5); and
when a score representing the fortune result is lower than a preset low standard, a “Print Discount Coupon” page is shown (Step A6), and the user may select to print a discount coupon or not.

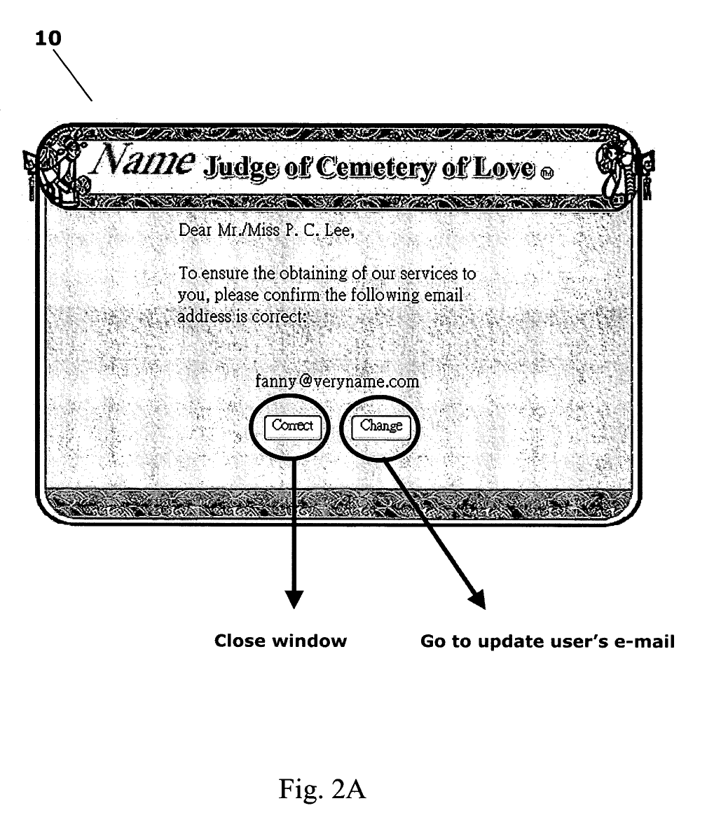

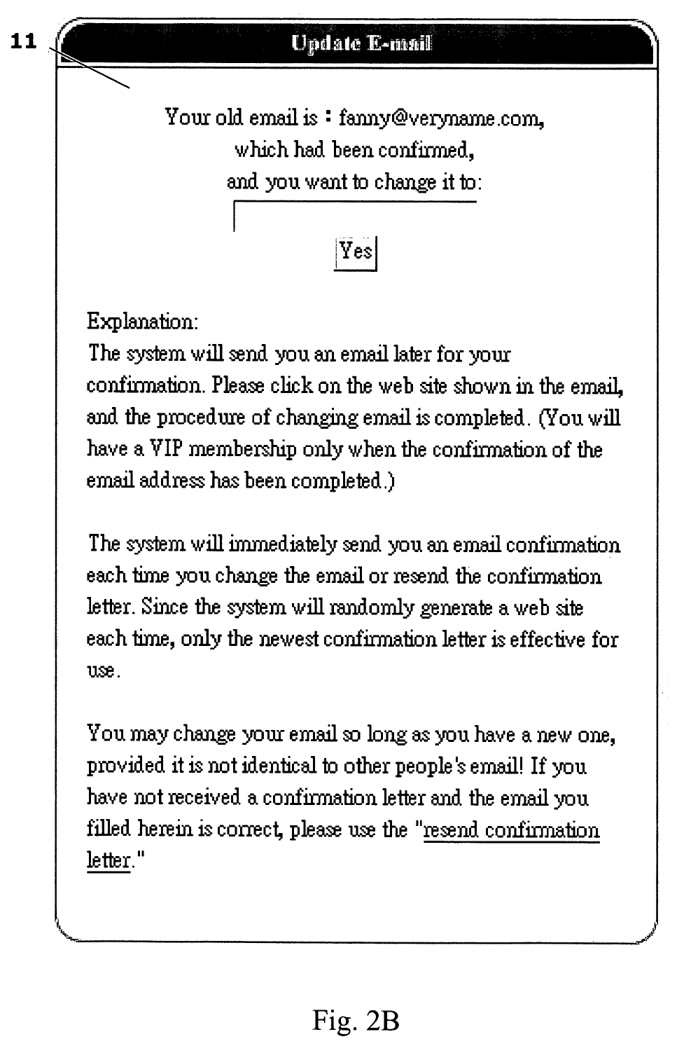

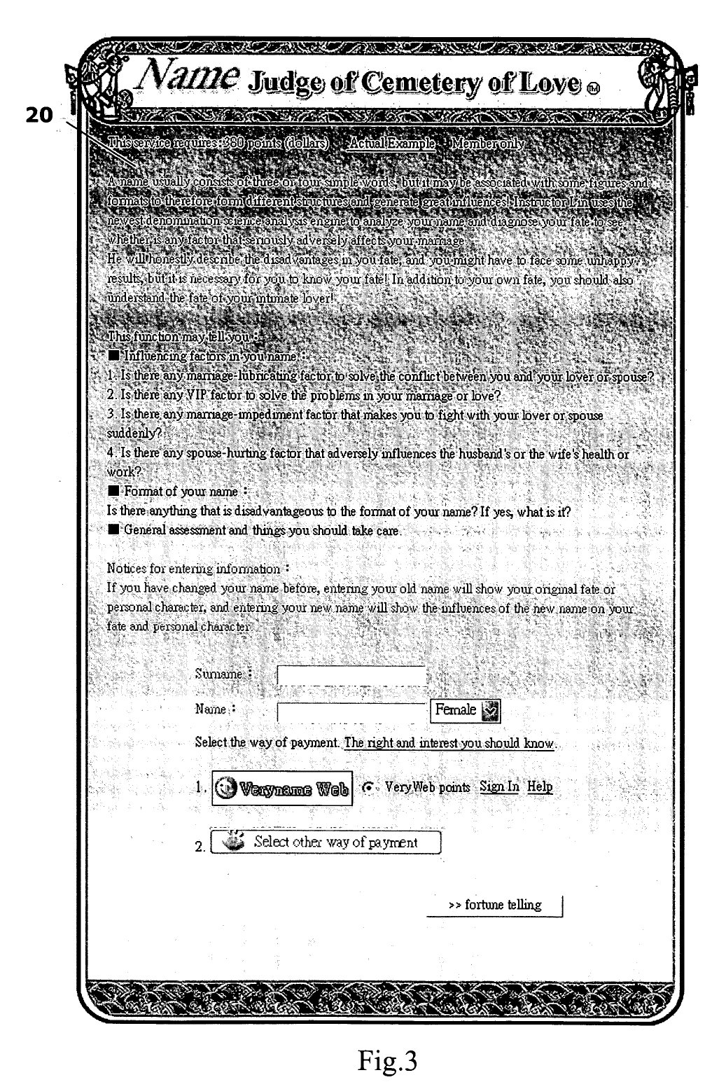

Please refer to FIGS. 2A and 2B in which a Membership dialog box 10 and an Email Address Change dialog box 11 are shown. Please also refer to FIG. 3 that shows an introductory page 20 for introducing the functions of the system and requesting the user to enter his or her personal information, such as name and sex. The page 20 is shown in the Step A2 of the method of the present invention.

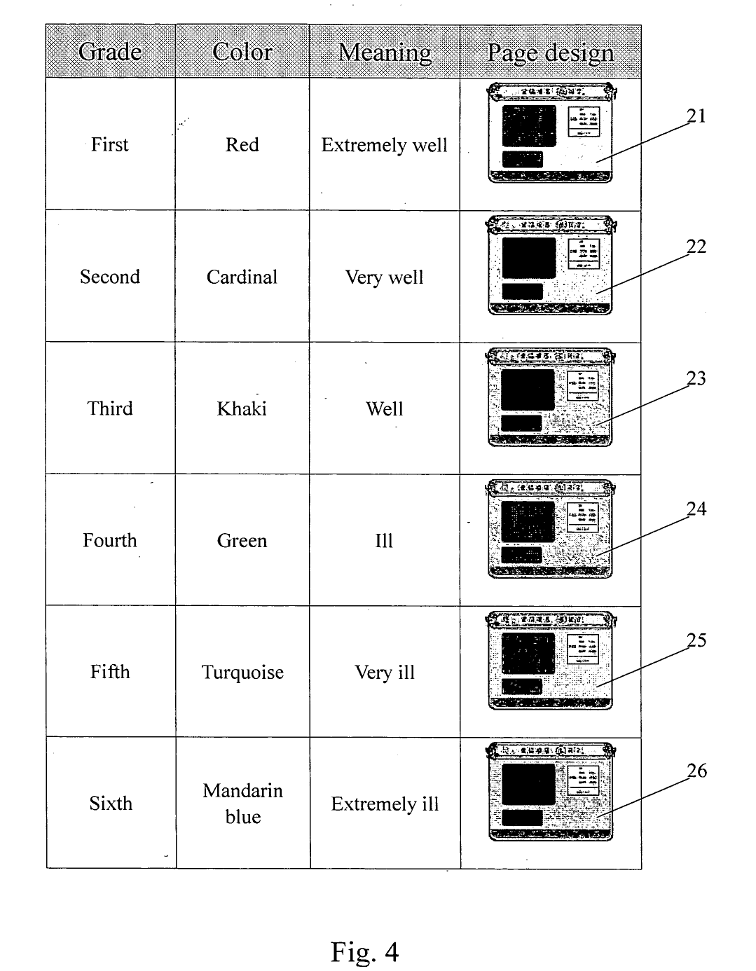

FIG. 4 is a fortune result reference table showing all possible analytic results of fortune generated in the Step A5 of the method of the present invention. In the reference table of Step A5, the fortune results are divided into two categories, namely, well and ill, and may be further divided into six grades from well to ill. The first grade means extremely well and is represented with a red color, and shown on an “extremely well” page 21; the second grade means very well and is represented with a cardinal red color, and shown on a “very well” page 22; the third grade means well and is represented with a khaki color, and shown on a “well” page 23; the fourth grade means ill and is represented with a green color, and shown on an “ill” page 24; the fifth grade means very ill and is represented with a turquoise color, and shown on a “very ill” page 25; and the sixth grade means extremely ill and is represented with a mandarin blue color, and shown on an “extremely ill” page 26.

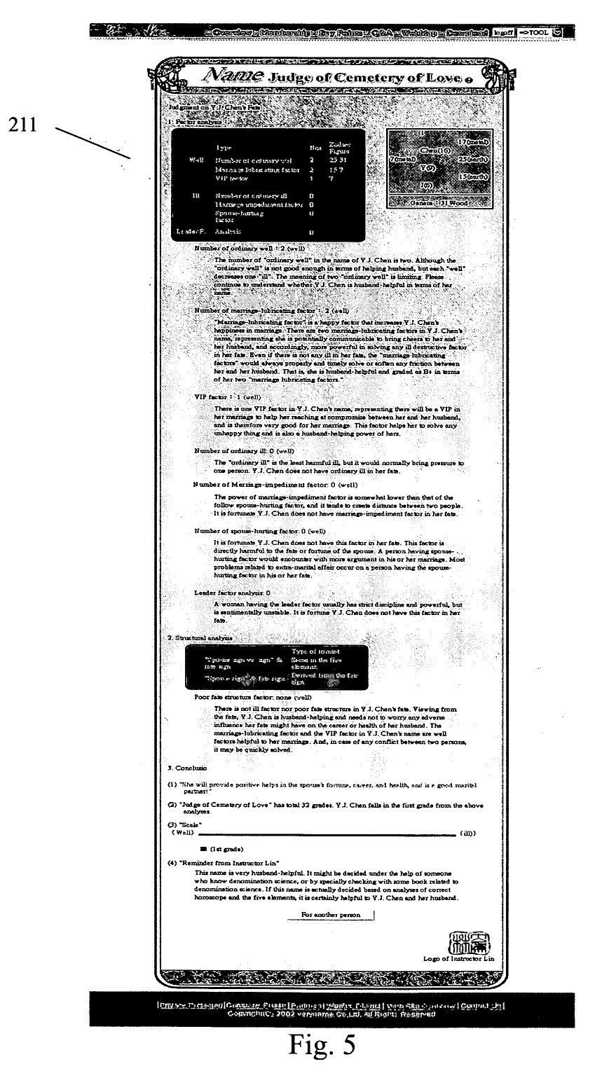

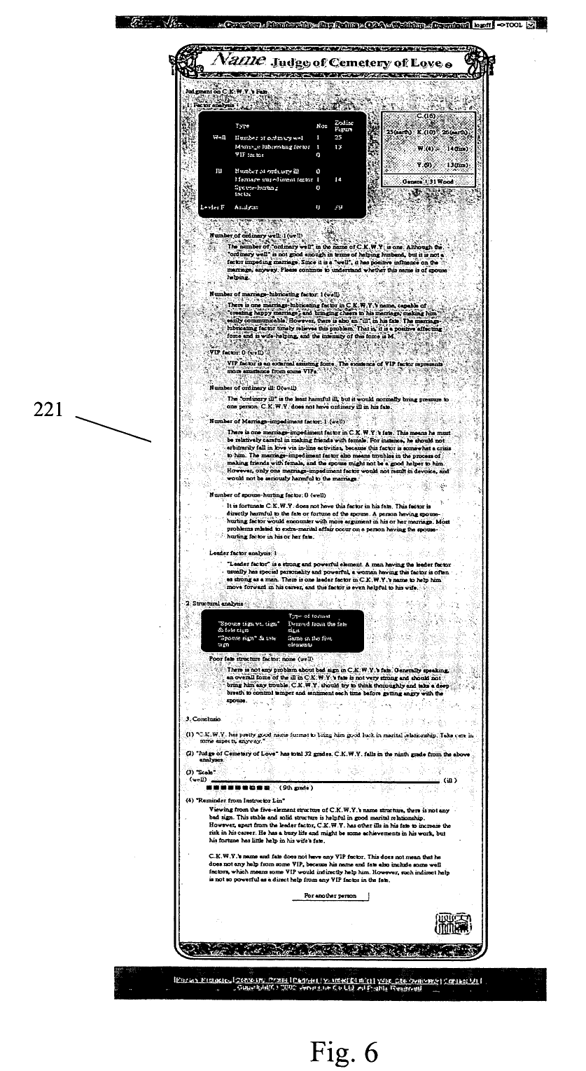

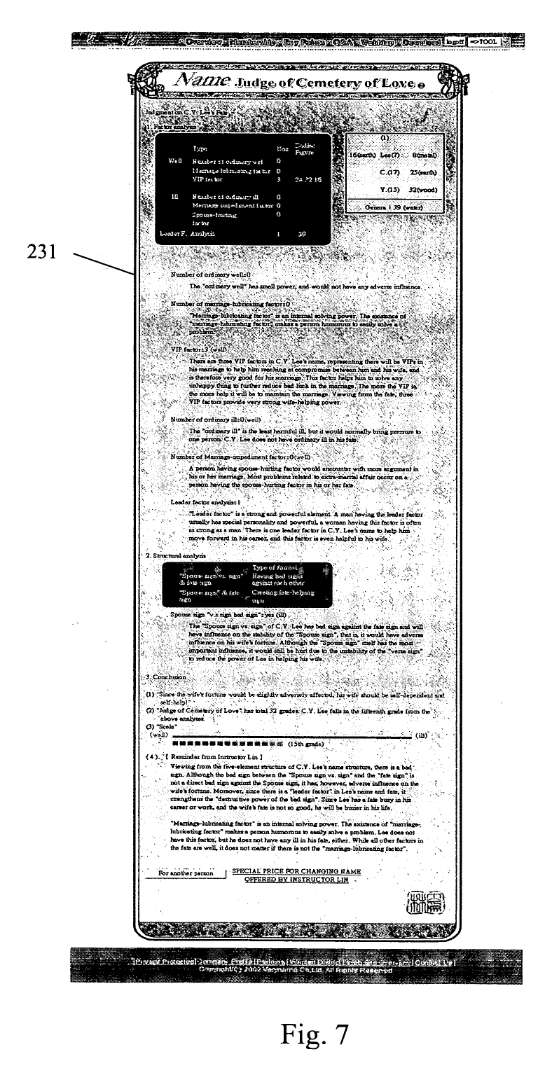

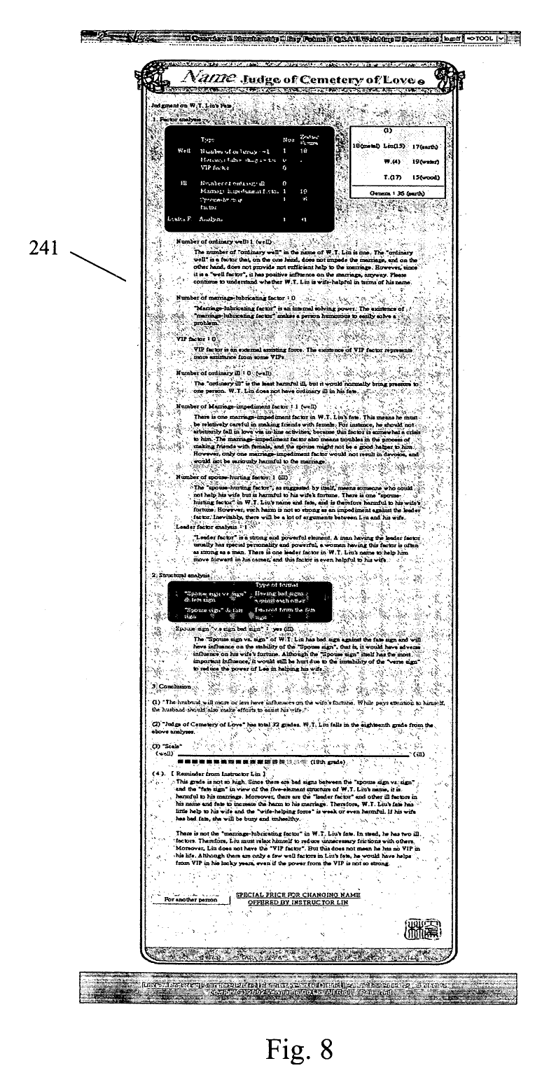

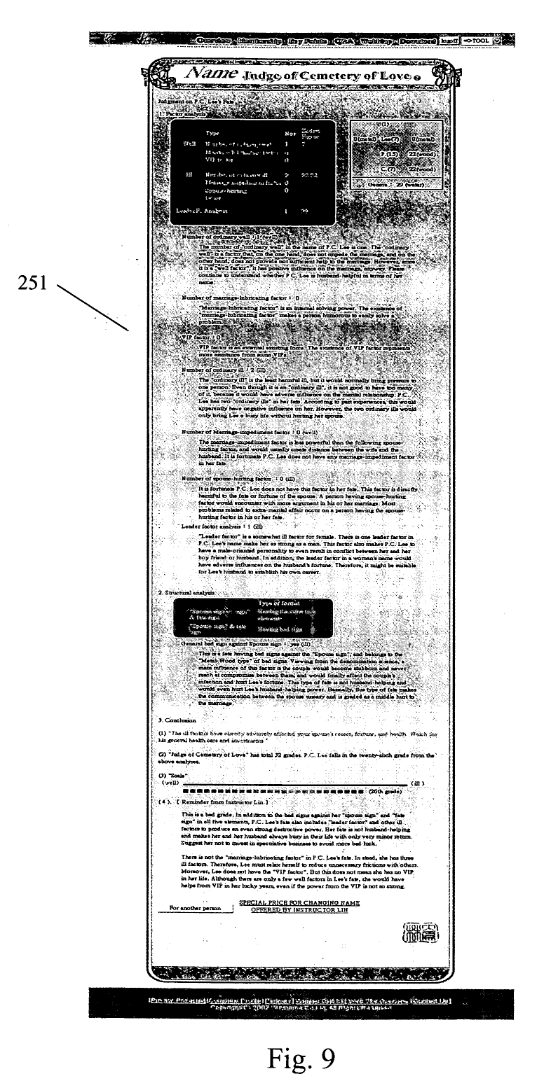

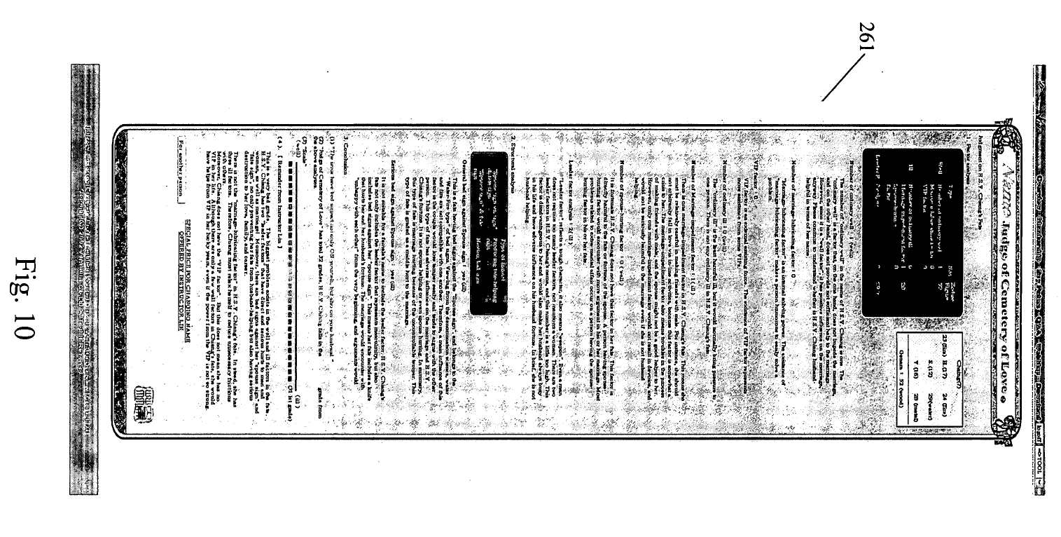

FIGS. 5 to 10 are six result pages 211, 221, 231, 241, 251, and 261 sequentially showing first to sixth examples of associating the fortune results generated at the Step A5 with their respective corresponding pages 21 to 26. These result pages are sequentially referred to as the “extremely well” result page 211, the “very well” result page 221, the “well” result page 231, the “ill” result page 241, the “very ill” result page 251, and the “extremely ill” result page 261.

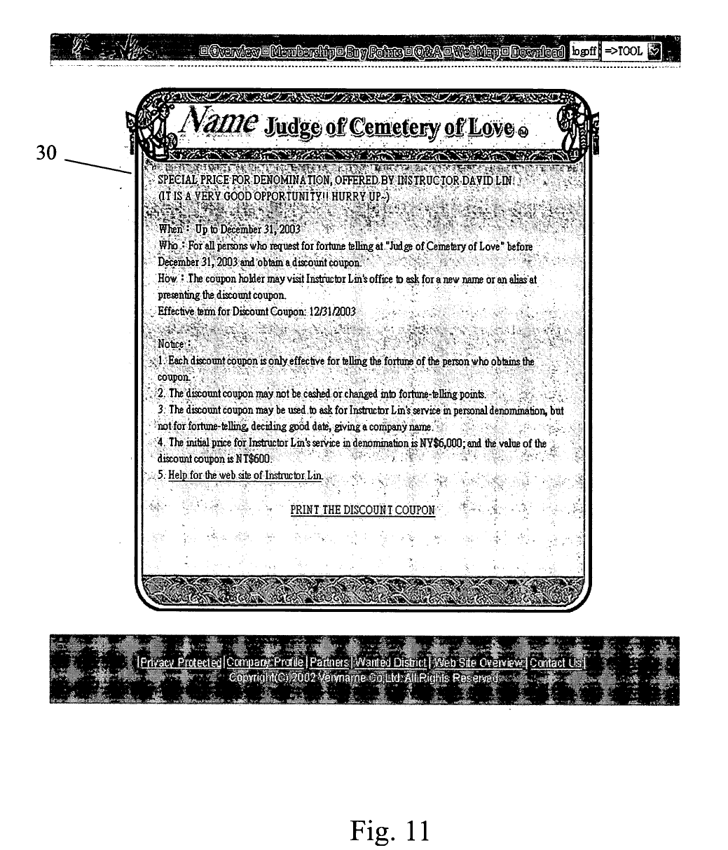

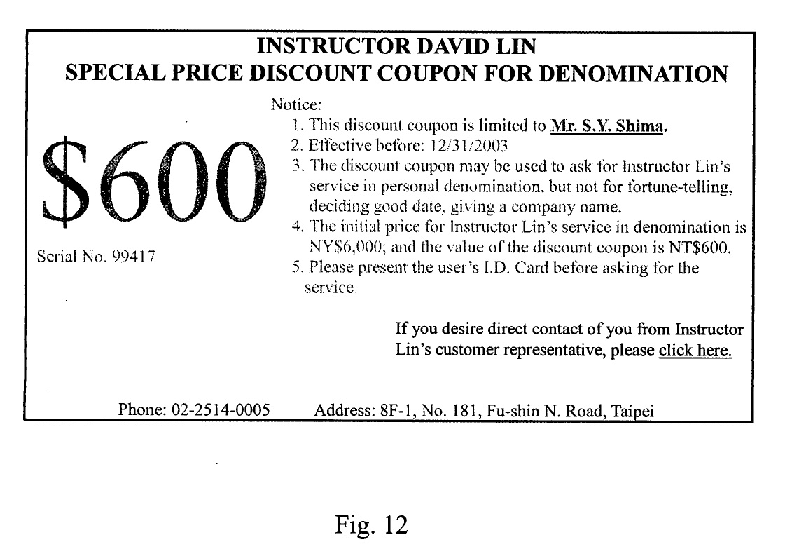

FIG. 11 is a page included in the system of the present invention, on which a user may enter to select printing a discount coupon; and FIG. 12 shows the discount coupon provided by the system of the present invention through the page of FIG. 11. When the fortune result generated in the Step A5 is associated with a corresponding page 21, 22, 23, 24, 25 or 26, a specific result page 211, 221, 231, 241, 251 or 261 is created. When the result page is any one of the “ill” result page 241, the “very ill” result page 251, and the “extremely ill” result page 261, a “Print Discount Coupon” page 30 is opened, and the user may select to print a discount coupon 31 or not. The above-mentioned fortune result obtained in the Step A5 is scored according to specific scoring standards, and the “ill” result page 241, the “very ill” result page 251 and the “extremely ill” result page 261 all have a score lower than a preset low standard.

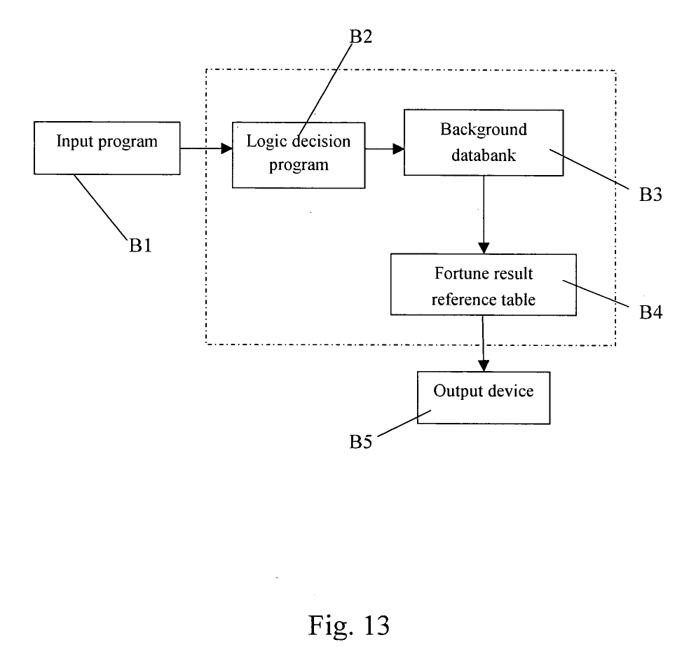

FIG. 13 is a block diagram showing a framework of the system of the present invention. As shown, the system of the present invention includes an input program B1 capable of reading and storing a string entered by the user; a logic decision program B2 for conducting logic operation on the string stored in the input program B1; a background databank B3, to data stored therein the string having been logically operated by the logic decision program B2 is corresponded to generate an analytic result; a fortune result reference table B4 including more than one page, with one of which the corresponding analytic result from the background databank is associated to generate a result page; and an output device B5 for showing the result page having associated the page from the fortune result reference table B4 with the analytic result. The input program B1 may be included in a web page of a web site to provide more than one input field for the user to enter personal information, such as the user's name. The pages of the fortune result reference table B4 are shown in different colors, such as, for example, red, cardinal, khaki, green, turquoise, and mandarin blue to indicate different fortune results. And, the pages of the fortune result reference table B4 includes at least two types, namely, well and ill pages, each of which may be further divided into three grades. Therefore, there are at least six pages to separately indicate six grades of well and ill, namely, the “extremely well” page 21, the “very well” page 22, the “well” page 23, the “ill” page 24, the “very ill” page 25, and the “extremely ill” page 26. And, the result pages generated from the fortune result reference table B4 include at least two types that may be further divided into six types, namely, the “extremely well” result page 211, the “very well” result page 221, the “well” result page 231, the “ill” result page 241, the “very ill” result page 251, and the “extremely ill” result page 261.

The output device B5 may be a screen of a computer, a screen on a mobile phone, or a screen on a personal digital assistant (PDA).

In brief, the present invention provides a method and a system for showing different web pages over Internet and wireless communication networks in specific page designs and colors to largely increase the efficiency of reading and determining the meaning of analytic information about fortune shown on the pages and to create increased fun in fortune telling over the Internet and the wireless communication networks, the present invention is therefore inventive when compared with the prior art.

The present invention has been described with a preferred embodiment thereof and it is understood that many changes and modifications in the described embodiment can be carried out without departing from the scope and the spirit of the invention that is to be limited only by the appended claims.

1. A system for showing web pages over Internet and wireless communication networks in different page designs and colors to indicate specific meanings of analytic information obtained on the basis of the denomination science for telling a user's fortune, comprising:
an input program for reading and storing a string entered by a user;
a logic decision program for conducting logic operation on said string stored in said input program;
a background databank, to which said string having been logically operated by said logic decision program is corresponded to generate an analytic result;
a fortune result reference table including more than on page, with one of which said analytic result generated by said background databank is associated to generate a result page; and
an output device for showing said result page.

2. The system as claimed in claim 1, wherein said input program provides more than one input fields.

3. The system as claimed in claim 1, wherein said input program is included in a web page.

4. The system as claimed in claim 2, wherein said input program is included in a web page.

5. The system as claimed in claim 1, wherein said pages of said fortune result reference table are shown in at least one color.

6. The system as claimed in claim 1, wherein said pages of said fortune result reference table are separately shown in red, cardinal, khaki, green, turquoise, and mandarin blue colors.

7. The system as claimed in claim 1, wherein said pages of said fortune result reference table include at least one type of page designs.

8. The system as claimed in claim 1, wherein said pages of said fortune result reference table include six types of page designs, namely, extremely well, very well, well, ill, very ill, and extremely ill pages.

9. The system as claimed in claim 1, wherein said result pages generated from said fortune result reference table includes at least two types of result page designs.

10. The system as claimed in claim 1, wherein said result pages generated from said fortune result reference table includes six types of result page designs, namely, extremely well, very well, well, ill, very ill, and extremely ill result pages.

11. The system as claimed in claim 9, wherein said result pages generated from said fortune result reference table includes six types of result page designs, namely, extremely well, very well, well, ill, very ill, and extremely ill result pages.

12. The system as claimed in claim 1, wherein said output device is a screen of a computer.

13. The system as claimed in claim 1, wherein said output device is a screen on a mobile phone.

14. The system as claimed in claim 1, wherein said output device is a screen on a PDA.

15. A method for showing web pages over Internet and wireless communication networks in different page designs and colors to indicate specific meanings of analytic information obtained on the basis of the denomination science for telling a user's fortune, comprising the steps of:
A1: opening a “membership” page and determining whether a user is a membership;
A11: opening an inviting page if the user is not a membership;
A2: opening an introductory page, on which functions of said web pages are introduced, and a user may enter personal information, such as name and sex;
A3: prompting the user to confirm the information entered on said introductory page is correct;
A4: corresponding a string of the entered information to a background databank;
A41: verifying the user's email address at the same time;
A42: updating the email address if the user wants to change the email address; and
A5: generating a fortune result according to data in the databank corresponding to the entered information.

16. The method as claimed in claim 15, further comprising the step of showing a “print discount coupon” page when said fortune result generated from said background databank does not meet a preset low standard.

17. The method as claimed in claim 15, wherein said fortune result includes at least two types, namely, well and ill.

18. The method as claimed in claim 17, wherein said two types of said fortune result are further divided into six grades, namely, extremely well, very well, well, ill, very ill, and extremely ill.

19. The method as claimed in claim 17, wherein said two types of said fortune result are separately shown in a specific color.

20. The method as claimed in claim 18, wherein said six grades of said fortune result are separately shown in a specific color.

21. The method as claimed in claim 17, wherein said two types of said fortune result are separately shown on a specific result page.

22. The method as claimed in claim 18, wherein said six grades of said fortune result are separately shown on a specific result page.

23. The method as claimed in claim 18, wherein said grade of extremely well is shown in red color and on an extremely well” result page, said grade of very well is shown in cardinal color and on a “very well” result page, said grade of well is shown in khaki color and on a “well” result page, said grade of ill is shown in green color and on an “ill” result page, said grade of very ill is shown in turquoise color and on a “very ill” result page, and said grade of extremely ill is shown in mandarin blue color and on an “extremely ill” result page.
